(19) United States
(12) Patent Application Publication
(10) Pub. No.: US 2006/0203179 A1
(43) Pub. Date: Sep. 14, 2006

(54) Method of manufacturing display device and method of manufacturing electric apparatus

(75) Inventor: Takeo Kawase, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/357,176

(22) Filed: Feb. 21, 2006

(30) Foreign Application Priority Data
Mar. 14, 2005 (JP) 2005-070864

(51) Int. Cl. G02F 1/13

(52) U.S. Cl. 349/187

(57) ABSTRACT

A method of manufacturing a display device, including the step of forming a liquid layer by applying a partition forming liquid on a substrate provided with an electrode, and the step of injecting a display fluid substantially nonmiscible with the partition forming liquid in a plurality of positions in the liquid layer to form a plurality of cells of the display fluid separated from each other.

### BACKGROUND OF THE INVENTION

1. Technical Field

The present invention relates to a method of manufacturing a display device equipped with information display elements, in particular with information display device using an electrophoretic material or liquid crystal.

2. Related Art

Electrophoretic display devices display information by controlling an electronic field applied to suspension composed of charged fine particles and a dispersion medium dispersing the charged fine particles. In the electrophoretic display devices, information is displayed by making the fine particles migrate to the viewing-substrate for showing the color tone of the fine particles or by making the fine particles migrate apart from the viewing-substrate for showing the color tone of the dispersion medium.

In this case, since the fine particles in the suspension are charged with electricity, the fine particles sealed between substrates while dispersed in a large amount of suspension may be agglutinated to be harden up on a part of the surface the substrate. In order for preventing this phenomenon, the suspension needs to be divided into a number of small cell-like areas with partitions. The following two kinds of methods have been used for forming the cell-like areas.

A first one is a partition-forming method. In this method, the partition is previously formed using a photolithography process or a mold process on a substrate provided with an electrode, and then the cell-like areas separated with the partition are filled with the suspension to be sealed with lids, and further, the other electrode is then provided. A second one is a microcapsule method. In this method, a group of microcapsules containing the suspension is previously formed, and the group of microcapsules is arranged or applied on the substrate provided with an electrode. For example, Japanese Patent No. 2,551,783 discloses an electrophoretic display device configured to dispose between the electrodes a number of microcapsules in which a dispersion system composed of a colored dispersion liquid and at least one kind of electrophoretic particles different from the colored dispersion liquid in optical characteristics and dispersed by the colored dispersion liquid is sealed.

According to the microcapsule method described above, if once the microcapsules are composed, it is enough to apply the microcapsules. Therefore, the method has an advantage that even a display device with a large area can easy be manufactured and has been thought to be more advantageous than the partition-forming method.

However, the microcapsule method also has a disadvantage.

Specifically, it has been difficult to precisely control the applying area or an arrangement of the microcapsules in applying the microcapsules. Namely, although the group of the microcapsules has been expanded all over the substrate utilizing a mechanical process using a roller or a squeegee, in the nature of the case, there is no need to dispose the microcapsules outside the display area. In view of connecting the wiring or sealing the display device, it is rather preferable that no microcapsule exists in the outer area of the display area. This is because the outer area of the display area is often used for running the wiring or providing a sealing member.

Further, in display devices for displaying color images, electrophoretic materials each including microcapsules recognized as showing different color tone from microcapsules included in other electrophoretic materials need to be arranged in a tiled manner. However, it has been difficult to apply the microcapsules to be recognized as showing different color tones in a tiled manner separately from each other. Namely, since the microcapsules are rather large particles, it has been difficult to evenly apply the group including the microcapsules, even uniformly on the substrate. It has accompanied even more serious difficulty to apply the microcapsules of different kinds to form microscopic tiles corresponding to the resolution of the display device.

### SUMMARY

An advantage of the invention is to provide a method of manufacturing a display device for forming microscopic cells containing a display fluid in high-resolution without providing microcapsules, and to provide an electric apparatus implementing the display device.

A method of manufacturing a display device according to an aspect of the invention includes the step of forming a liquid layer by applying a partition forming liquid on a substrate provided with an electrode, and the step of injecting a display fluid substantially nonmiscible with the partition forming liquid in a plurality of positions in the liquid layer to form a plurality of cells of the display fluid separated from each other.

Further, a method of manufacturing a display device using a display fluid according another aspect of the invention includes the step of

forming a liquid layer by applying partition forming liquid on a substrate, and the step of placing a display fluid nonmiscible with the partition forming liquid in the liquid layer in a plurality of positions in the liquid layer, thereby forming a plurality of cells of the display fluid separated from each other.

According to the method described above, the partition forming liquid is applied and the liquid layer in a liquid state is formed instead of forming a solidified partitions or forming microcapsules. Since the display fluid is placed in a number of positions in the liquid layer in separated conditions, each of the separated display fluid forms a display fluid cell. The liquid layer separating the cells functions as the partitions. According to the method described above, firstly, since disposing the fluid in a desired positions in the liquid layer is as easy as anything in comparison with applying microcapsules in microscopic areas, the display fluid cells containing the display fluid can be formed in high-resolution. Secondly, since the step of forming the partition is not necessary, the waste in the partition material can be suppressed to the minimum.

Note that the expression of “substantially nonmiscible” in the invention includes not only the case in which it is completely, 100% nonmiscible therewith, but also the case in which it is blended in some amount but can be regarded as practically nonmiscible.

Here, the step of solidifying the partition forming liquid forming the liquid layer is further provided. According to this method, the partition forming liquid forming the liquid layer is solidified after the display fluid is disposed in the liquid layer, thus the positions of the microscopic cells can be fixed. Although the solidifying method is not particularly limited, the partition forming liquid can be cured by, for example, drying or heating.

In the invention, as the method of “injecting” the display fluid and “placing” it in the liquid layer, various methods can be considered, but ejection from a liquid ejecting device is preferable. By using the liquid ejecting device, droplets of the display fluid can be dropped at desired positions, and further, it is possible to give a certain speed to the droplets, thus the droplets overcome the interfacial energy between the display fluid and the partition forming liquid in landing thereon to be inserted in the liquid layer and placed inside the liquid layer. As the liquid ejecting device, for example, a device having a similar structure to the inkjet head can be adopted.

In this case, it is preferable that two or more of different kinds of display fluids are injected in different positions in the liquid layer. Depending on the purpose of display, the different kinds of fluids may be provided on the same substrate. According to this aspect of the invention, since the arrangements of the display fluids are not particularly limited, it is possible to use different kind of display fluid in accordance with the arrangement.

For example, it can be considered that display fluids having different display colors are disposed in different positions in the liquid layer. In color display devices, it is required that the pixel elements each showing a primary color are arranged adjacent to each other in a pixel. According to this aspect of the invention, the display fluids having different display colors can be disposed adjacent to each other.

As the display fluid used in the invention, a suspension having at least one kind of particles dispersed in a dispersion medium can be cited. This is the case with a so-called electrophoretic display element, and also the case in which the color tone is changed in accordance with the kind of particles or dispersion medium.

Further, as the display fluid used in the invention, a liquid crystal material can also be used. Because, even the liquid crystal material can be used for a display by divided into a number of cells. And the invention is suitable for such a case.

The invention also has an aspect of an electric apparatus manufactured using the method of manufacturing the display device described above. Such an electric apparatus is a product having a configuration to be sold and transferred in a commercial transaction

for example, electronic paper, display devices including those with large screens, television devices including those with large screens, a videocassette recorder of a viewfinder type or of a direct view monitor type, a car navigation system, a pager, an electronic notepad, an electronic calculator, an electronic newspaper, a word processor, a personal computer, a workstation, a video phone, a POS terminal, an instrument equipped with a touch panel can be included. The display device according to the invention can be applied as a display section of each of the above instruments.

Further, the electric apparatus according to the invention includes, providing it is manufactured using the method according to the invention, those excluded from the concept of a device such as a flexible object shaped like paper or a film, those belonging to real estate such as a wall face to which these objects are attached, or those belonging to a vehicle, a flight vehicle, boats and ships

### BRIEF DESCRIPTION OF THE DRAWINGS

The invention will now be described with reference to the accompanying drawings, wherein like numbers refer to like elements.

FIG. 1 is an enlarged cross-sectional view of a display device according to a first embodiment.

FIGS. 2A through 2D are cross-sectional views showing a manufacturing process of the first embodiment, wherein FIG. 2A shows a liquid layer forming process, FIG. 2B shows the state after forming the liquid layer, FIG. 2C shows a display fluid cell forming process, and FIG. 2D shows a solidification forming process.

FIGS. 3A and 3B are cross-sectional views showing the manufacturing process of the first embodiment, wherein FIG. 3A shows a bonding process, and FIG. 3B shows a substrate laminating process.

FIGS. 4A through 4C are cross-sectional views showing a manufacturing process of the second embodiment, wherein FIG. 4A shows a display electrodes forming process, FIG. 4B shows a display fluid cell forming process, and FIG. 4C is an enlarged cross-sectional view of the display device.

FIG. 5 is a block diagram of an electrophoretic device.

FIG. 6A is a schematic view of a large-sized television device as an example of an electric apparatus.

FIG. 6B is a schematic view of an electronic paper device as an example of the electric apparatus.

### DESCRIPTION OF THE EMBODIMENTS

Hereinafter, preferred embodiments of the invention are described with reference to the accompanying drawings.

The embodiments described below are nothing more than exemplifications, and the invention can diversely be modified within the scope or the spirit of the invention.

### First Embodiment

A first embodiment of the invention is for exemplifying the case in which the invention is applied to the manufacture of an electrophoretic display device.

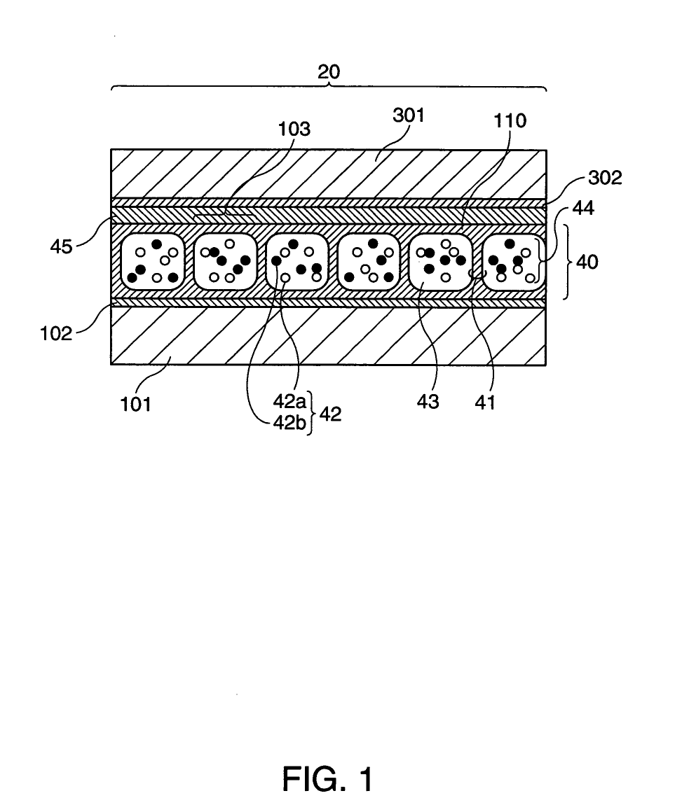

FIG. 1 is a schematic cross-sectional view of the electrophoretic display device according to the present embodiment. The cross-sectional view is a enlarged cross-sectional view for a single pixel region.

As shown in FIG. 1, a display device 20 has a configuration in which a substrate 101 provided with a display electrode 102 and an opposed substrate 301 provided with an opposed electrode 302 sandwiches a liquid layer 40. In the liquid layer 40, there are provided with display fluid cells 103 disposed in a configuration in which each of the cells is separated with a partition 41.

The composing materials of the substrates and the electrodes are differently determined depending on which substrate the display device 20 is designed to be viewed from. Namely, the substrate and the electrode in the side of the display surface are formed of materials having optical transparency, preferably of transparent materials (including transparent and colorless, transparent and colored, and translucent materials). This is because, by thus configuring, the states of the particles 42 in the display fluid cells 103, namely the information (image) displayed on the display device 20 can be observed.

Each of the display fluid cell 103 is supplied and filled with a suspension 44 as the display fluid. The suspension 44 is composed of a dispersion medium 43 and the particles 42 of one or more kinds (two kinds here) dispersed in the dispersion medium 43. The particles 42 are divided into first particles 42a charged positively and second particles 42b charged negatively in the present embodiment. The average diameter of the display fluid cells 103 is preferably in a range of about 20 through 200 μm, and further preferably in a range of about 30 through 150 μm.

In the structure described above, when a predetermined voltage is applied between the display electrode 102 and the opposed electrode 302, the second particles 42b charged negatively migrate towards the electrode becoming the positive side while the first particles 42a charged positively migrate towards the electrode becoming the negative side. For example, in FIG. 1, it is assumed that observation is made from the lower substrate 101. In the case in which the opposed electrode 302 becomes the positive electrode and the display electrode 102 becomes the negative electrode, the negatively charged second particles 42b electrically migrate closer to the opposed electrode 302 while the positively charged first particles 42a electrically migrate closer to the display electrode 102 and are then accumulated. When observed from the substrate 101, since only the first particles 42a charged positively in the same way exist in the side of the substrate 101, the color tone of the first particles 42a can be observed. On the contrary, in the case in which the voltage is applied so that the opposed electrode 302 becomes the negative electrode and the display electrode 102 becomes the positive electrode, the negatively charged second particles 42b in turn electrically migrate closer to the display electrode 102 while the positively charged first particles 42a electrically migrate closer to the opposed electrode 302 and are then accumulated. In this case, since the negatively charged second particles 42b is accumulated in the side of the substrate 101, the color tone of the second particles 42b can be observed. Further, when no voltage is applied between the electrodes, accumulation of the particles 42 does not occur in either of the substrates, and accordingly, about the same color tone as the dispersion medium 43 can be observed. Still further, when no electric field is applied thereto, each of the particles 43 is kept evenly dispersed in the dispersion medium 43. Therefore, when no electric field is applied, no particular accumulation of the particles exists on the side of the substrate 101, and accordingly, the color tone of the dispersion medium 43 can be observed. Assuming that the color tone of the dispersion medium 43 is an achromatic color, such as white, white is displayed when no voltage is applied thereto.

As described above, by appropriately selecting the physical properties (e.g., color tone, charged polarity, amount of charge, etc) of the particles 42, the polarities of the display electrode 102 and the opposed electrode 302, an amount of electrical potential difference (voltage) between the both electrodes, and so on, a color determined by the color tones of the particles 42 and the color tone of the dispersion medium 43 is expressed, and by microscopically controlling the applied voltage, desired information (images) can be displayed as a whole.

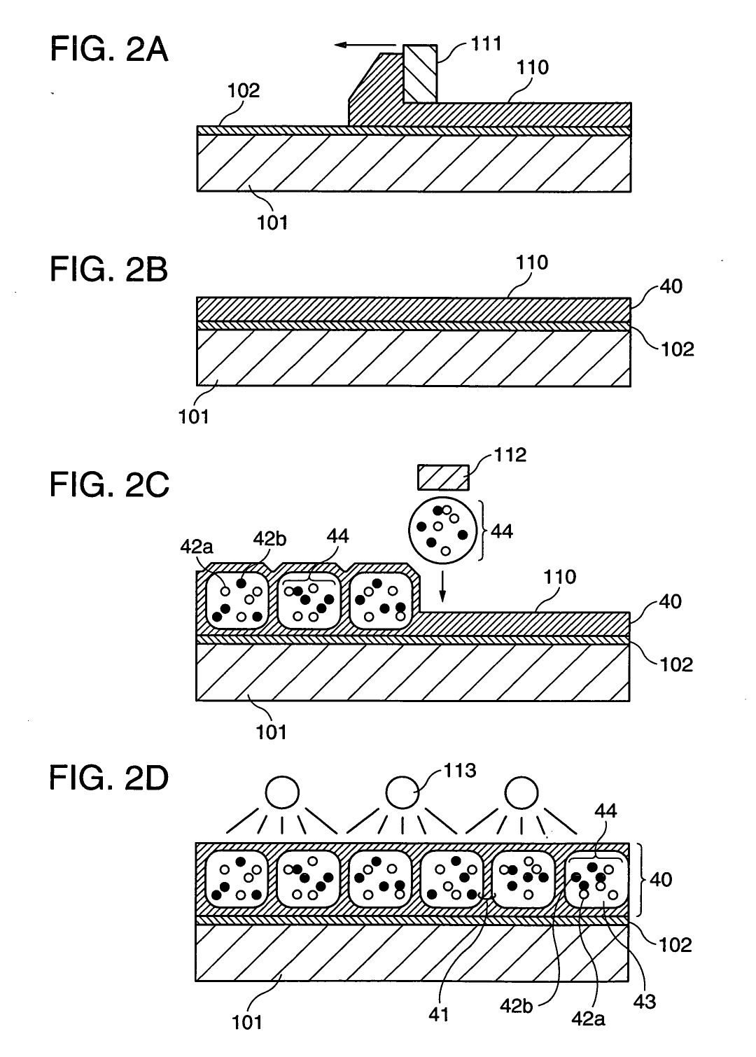

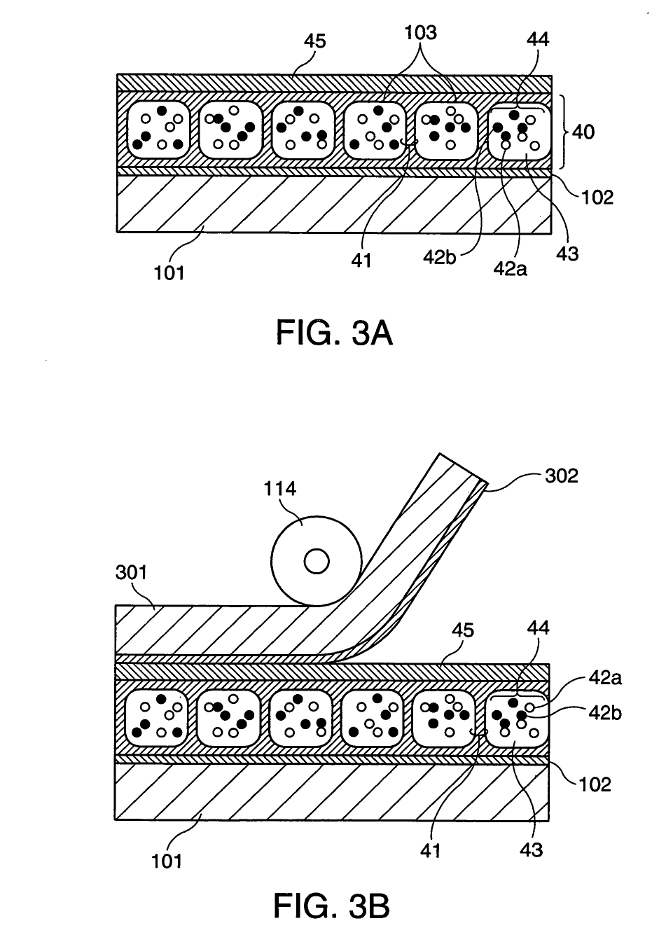

FIGS. 2A through 2D, 3A, and 3B are cross-sectional views showing a manufacturing process for explaining a manufacturing method of the display device according to the present embodiment. The present embodiment of the invention, in particular, has a feature in the forming process of the display fluid cell 103, which will hereinafter be explained.

Liquid Layer Formation: FIG. 2A

As shown in FIG. 2A, the liquid layer 40 is formed on the substrate 101 provided with the display electrode 102 by applying partition forming liquid 110 thereon.

As a material of the substrate 101, glass or resin can be adopted. If the display device needs to have flexibility as a whole, resin (film) having flexibility such as polyethylene naphthalate is preferably used as the substrate. If the substrate is used as the display surface (the light is transmitted toward the bottom of the figure), the substrate 101 is formed with a material having light permeability, preferably a substantially transparent (including transparent colorless, transparent colored, and translucent) material. Although not shown in the drawings, a barrier layer for blocking oxygen and moisture is preferably formed on the substrate 101 with, for example, silicon oxide (SiO₂) or the like. The display electrode 102 is formed of a metal material or the like having electrical conductivity by forming a film with a known thin film metal material such as aluminum, titanium, platinum, or gold to have a predetermined thickness using a thin film forming method such as a sputtering process or a vapor deposition process. If the substrate 101 is used as the display surface, the display electrode 102 is formed of an electrically conductive material having light permeability such as indium titanium oxide (ITO). The display electrode 102 is previously patterned in accordance with a drive configuration (e.g., whether it is an active matrix drive system or the a passive matrix drive system) of the display device.

Meanwhile, as a first feature, the partition forming liquid 110 needs to include a fluid at the time of forming to have conditions for injecting drops of suspension 44 which is a display fluid. Further, as a second feature, the partition forming liquid 110 is required to be a material to be substantially separated from and never blended with (never dissolved by) the display fluid described later. As a third feature, in solidification, the partition forming liquid 110 is required to be a material solidified in the solidification process described later to fix the display fluid cells 103. Although the composition of the partition forming liquid is not particularly limited, a liquid including water is used as the partition forming liquid 110 for forming the liquid layer 40 here considering that an organic solvent is used for the suspension 44. As the material, which can be included in water and solidified, polymeric materials, preferably water-soluble polymeric materials are preferably used.

As the polymeric material, polymethylmethacrylate, polystyrene, polycarbonate, polyolefin group, epoxy resin, and so on can be used. As the water-soluble polymeric materials, a water solution of gelatin or Arabic gum, or those including polyvinyl alcohol are preferable. Further, it can be arranged that epoxy resin or acrylate resin is formed from water-soluble monomers. Still further, using water as the dispersion medium of the partition forming liquid, water dispersed emulsions containing emulsionized materials such as silicone resin, acrylic resin, epoxy resin, polycarbonate resin and so on can also be adopted.

In the first embodiment, since the organic solvent is used as the dispersion medium 43 of the suspension 44, which is the display fluid, various solutions, colloidal liquids, emulsion liquids, or polymeric monomer liquids nonmiscible therewith can be used as the partition forming liquid. In particular, some of the polymeric monomers are fluid, and are preferable because they do not necessarily require solvents.

After applied, the partition forming liquid 110 needs to have conditions (The surface energy of a droplet of the display fluid (suspension) is greater than the interfacial energy between the partition forming liquid and the suspension.) for allowing the display fluid to enter on the one hand, it is required to keep the form, in which it is applied, to some extent (for a period until it is solidified if it is solidified, or semipermanently if it is not solidified) on the other hand. In this reason, it is necessary to adjust the viscosity of the partition forming liquid 110 with a solvent or the like. In the viscosity adjustment described above, the viscosity is preferably adjusted so that the partition forming liquid can accommodate in the layer the suspension 44, which is the display fluid ejected thereto, and that it keeps the thickness of the layer but does not flow out.

In particular, a measure for suppressing evaporation of the solvent or the dispersion medium is preferably taken to prevent that the solvent or the dispersion medium evaporate from the liquid layer 40 to cause the viscosity to become too high. As such a measure, it is preferable that the vapor pressure of the solvent or the dispersion medium in the atmosphere in which the liquid layer 40 is hold is set higher. For example, if the liquid layer 40 includes water, it is effective to set the water vapor pressure in the atmosphere to a high level. Specifically, by setting the water vapor pressure to be near the saturated water vapor pressure, the moisture, the dispersion medium, can be prevented from evaporating from the liquid layer 40.

As shown in FIG. 2A, various methods can be applied to the application of the partition forming liquid 110. FIG. 2A shows a process of applying the partition forming liquid 110 in a substantially even thickness using a doctor blade 111. As a method of application, other than the doctor blade method, a spin-coat method, a screen print method, an inkjet method, a spray method, and so on can be used by appropriately selecting in accordance with the application area or available environmental conditions.

The thickness of the applied partition forming liquid 110 is determined in relation to the average diameter of the display fluid cells 103. If the light permeability of the partition forming liquid 110 is relatively high, it can be formed rather thick. However, if the light permeability is relatively low, it is preferably formed rather thin. If the average diameter of the display fluid cells 103 is in a range of about 20 μm through 200 μm, the thickness of the liquid layer 40 formed by applying the partition forming liquid 110 is set in a range of about 1 μm through 30 μm. This is because, with the thickness of this range, when the suspension 44 is ejected thereto, the partition forming liquid 110 preferably comes round above the suspension 44 to surround the suspension 44 inside the liquid layer.

As shown in FIG. 2B, by the liquid layer forming process described above, the liquid layer 40 composed of the partition forming liquid 110 of an even thickness can be formed.

Display Fluid Cell Formation: FIG. 2C

As shown in FIG. 2C, the suspension 44, which is the display fluid, is injected to be included in the liquid layer 40 formed as described above.

As the suspension 44, any kinds of electrophoretic display liquid can be adopted, but is required to be a material substantially nonmiscible with the partition forming liquid 110 forming the liquid layer 40. An example of method of adjusting the suspension 44 will hereinafter be described.

The suspension 44 is the electrophoretic display liquid composed of a dispersion medium 43 and the particles 42 of one or more kinds dispersed in the dispersion medium 43. Since the partition forming liquid containing water is used as the liquid layer 40, an organic solvent nonmiscible therewith is used as the dispersion medium 43. As the organic solvent, dodecylbenzene, tetramethylbenzene, cyclohexylbenzene, tetrafluorodibromoethane, tetrochloroehtylene, and so on can be used. Specifically, ISOPAR™ (the brand name), the product of Exxon Mobil Corporation, can be used.

If the particles 42 dispersed in the dispersion medium 43 are single species, the particles can be either those to be charged positively or those to be charged negatively. If the particles of single species are used, a solvent having a color tone, chromaticness, or brightness different form the color tone of the particles is preferably used as the dispersion medium 43. As the particles 42, various known pigments can be used. As organic pigment particles, for example, fast yellow, disazo yellow, condensed azo yellow, anthrapyrimidine yellow, isoindoline yellow, copper azomethin yellow, quinophthaloine yellow, benzimidazolone yellow, nickel dioxime yellow, monoazo yellow lake, dinitroaniline orange, pyrazolone orange, perinine orange, naphthol red, toluidine red, permanent carmine, brilliant fast scarlet, pyrazolone red, rhodamine 6G lake, permanent red, lithol red, bon lake red, lake red, brilliant carmine, bordeaux 10B, quinacridone magenta, condensed azo red, naphthol carmine, perylene scarlet, condensed azo scarlet, benzinidazolone carmine, anthraquinonyl red, perylene red, perylene maroon, quinacridone maroon, quinacridone scarlet, quinacridone red, diketopyrrolopyrrole red, benzimidazolone brown, phthalocyanine green, victoria blue lake, phthalocyanine blue, fast sky blue, alkali blue toner, indanthrone blue, rhodamine B lake, methyl violet lake, dioxazine violet, naphthol violet can be cited.

Further, as inorganic pigment particles which can be used as the particles 42, zinc white, zinc oxide, lithopone, titanium dioxide, zinc sulfide, antimony oxide, calcium carbonate, kaolin, mica, barium sulfate, gloss white, alumina white, talk, silica, calcium silicate, cadmium yellow, cadmium lipotone yellow, yellow iron oxide, titanium yellow, titanium barium yellow, cadmium orange, cadmium lipotone orange, molybdate orange, colcothar, red lead oxide, vermilion, cadmium red, cadmium lopotone red, umber, brown iron oxide, zinc-iron-chrome brown, chrome green, chrome oxide, viridian, cobalt green, cobalt-chrome green, titanium-cobalt green, iron blue, cobalt blue, ultramarine blue, cerulean blue, cobalt-aluminum-chrome blue, cobalt violet, mineral violet, carbon black, iron black, manganese ferrite black, cobalt-ferrite black, copper-chrome black, copper-chrome-manganese black, black low-oxide titanium (titanium black), aluminum powder, copper powder, lead powder, tin powder, zinc powder, and so on can be cited.

Further, if two kinds of particles 42 are used, the first particles 42a charged positively and the second particles 42b charged negative are required. Therefore, particles having fixed charging polarities or particles whose charging polarities can easily be controlled are preferably used. For example, by applying a surface treatment to the organic or inorganic pigment particles described above with a surface treatment agent, the second particles 42b to be charged negatively can be provided. For example, the surface treatment agent utilizing silane coupling agents, titanate coupling agents, chrome coupling agents, aluminum coupling agents, or germanium coupling agents can control the charge amount. Specifically, as the titanate coupling agent, “KR TTS,” the product of Ajinomoto Fine-Techno Co. Inc. is preferable, and as the aluminum coupling agent, “AL-M,” the product of Ajinomoto Fine-Techno Co. Inc. is preferable.

For example, as the first particles 42a to be charged positively, resin particles are preferably used. This is because, it is proved that, if inorganic pigment particles, for example, titanium oxide is used as the first particles 42a, the cohesive property with the resin particles is especially low. As the resin particles, particles manufactured using, for example, an emulsion polymerization method can be used. For example, as the first particles 42a, acrylic resin, polyurethane resin, urea resin, epoxy resin, melamine resin, polystyrene, divinylbenzene, and so on can be used alone or in combination. Those including polar radicals (functional groups) such as hydroxyl group, amino group, carboxyl group are preferable for the resin. This is because, it becomes nonmiscible with the solvent and stably exists in the dispersion medium 43.

As the combination of the first particles 42a and the second particles 42b, it is particularly preferable to use titanium oxide as the second particles 42b and acrylic resin as the first particles 42a. Because the inorganic particles including titanium oxide show a high degree of whiteness and have particularly low cohesive properties with the resin particles. Further, this is because the acrylic resin has a particularly low cohesive property with the inorganic particles such as titanium oxide.

Further, assuming the average particle diameter of the inorganic particles used as the second particles 42b is A, and the average diameter of the resin particles used as the first particles 42a is B, a relationship between A and B preferably satisfies that the value of B/A is in a range of 1.5 through 2000, and further preferably in a range of 5 through 50. This is because, by satisfying such a relationship, the dispersibility of the inorganic particles and the resin particles in the dispersion medium 43 can be maintained to be an appropriate value, thus efficiently preventing the aggregation of the inorganic particles and the resin particles.

Further, the average particle diameter B of the resin particles, which are the first particles 42a, is preferably in a range of about 0.5 through 20 μm, and more preferably in a range of about 2 through 10 μm. This is because, if the average particle diameter of the resin particles is in this range, the advantages described above can more appropriately obtained, and at the same time, the size of the display fluid cell 103 can be prevented from increasing, and the manufacturing efficiency of the display fluid cell 103 can be prevented from degrading.

Meanwhile, the average particle size of the inorganic particles, which are the second particles 42b, is preferably in a range of about 0.1 through 10 μm, more preferably in a range of about 0.1 through 7.5 μm, and further more preferably in a range of about 0.2 through 0.3 μm.

Note that if the surface treatment with the surface treatment agent (interfacial active agent) is applied to the inorganic particles, which are the second particles 42b, and the resin particles having a too small average particle diameter are used, the inorganic particles might problematically enter the hydrophobic chains of the surface treatment agent to cause aggregation of the inorganic particles with the resin particles. In this respect, by setting the average diameter of the resin particles to no less than 0.5 μm, such aggregation can efficiently be prevented.

Further, the gravities of the resin particles as the first particles 42a and the inorganic particles as the second particles 42b are preferably set to be approximately identical to that of the dispersion medium 43. This is because, by thus setting, the state in which the particles are appropriately dispersed in the dispersion medium can be maintained.

The suspension 44 is formed by slowly agitating to disperse a proper amount of particles 42 (the first particles 42a and the second particles 42b) in the dispersion medium 43. Regarding the dispersion method of the particles 42, the dispersion method, which have been used for manufacturing electrophoretic display liquids, can be adopted.

As shown in FIG. 2C, the suspension 44 thus manufactured is elected from a liquid ejecting device 112.

As the liquid ejecting device 112, those having the same structure as inkjet recording head, which have been used in the past, can be used. As the structure for liquid ejection, various method such as, for example, a piezoelectric jet system, an electrostatic system, or a heating pressurizing system can be used. The suspension is supplied instead of the ink to continuously eject a proper amount from a nozzle of the liquid ejecting device 112. The area to which the suspension 44 is ejected is set to be the display area on the substrate 101.

In this case, the liquid ejecting device 112 is preferably controlled to move relatively to the substrate 101 so that the ejected droplets of the suspension 44 are not blended with each other. Each of the droplets of the suspension 44 ejected and inserted inside the liquid layer 40 is to form the display fluid cell 103 in a separated condition. By adjusting the amount of the suspension ejected from the liquid electing device 112, the frequency of ejection, the relative speed of the liquid ejecting device to the substrate, to sequentially form the display fluid cells 103 inside the liquid layer 40 in an even density suitable for display. The amount of ejection of the suspension, the frequency of ejection, and the relative speed of the liquid ejecting device 112 to the substrate 101 depend on the volume of the droplet(s) ejected each time from the liquid ejecting device and how the droplet expands in the liquid layer 40 after it is ejected. Therefore, the optimal values are preferably determined by experiments.

The surface energy of the droplet of the suspension 44 is preferably larger than the interfacial energy of the droplet of the suspension in the partition forming liquid forming the liquid layer 40 in order to make the droplet of the suspension 44 ejected from the liquid ejecting device 112 and landing on the liquid layer 40 enter inside the liquid layer 40. If such a condition is fulfilled, the droplet of the suspension is covered with the partition forming liquid 110 of the liquid layer 40 by itself. Therefore, in order for adjusting the interfacial energy, an adjuster such as an interfacial active agent or an additive agent can previously be added to the partition forming liquid 110 for forming the liquid layer 40 or the suspension 44 according to need.

Further, in addition to the element described above, the ejection speed (flight speed) of the droplet ejected from the liquid ejecting device 112 can also be adjusted. In particular, in the case in which the relation ship between the surface energy and the interfacial energy described above is not satisfied, or the case in which the gravity of the suspension droplet is smaller than the gravity of the partition forming liquid for forming the liquid layer 40, it is difficult for the droplet to enter inside the liquid layer 40 unless the droplet is ejected with a speed higher than a predetermined speed. Therefore, the ejection speed of the droplet ejected from the liquid electing device 112 is preferably adjusted to be in a range of about 2 through 12 m/s.

Note that, although FIG. 2C shows the example of ejecting the droplets of the suspension 44 from above the liquid layer 40, it may be better to supply the suspension 44 from below the liquid layer 40 in some cases. For example, if the gravity of the suspension 44 is smaller than the gravity of the partition forming liquid 110 for forming the liquid layer 40, the injected droplets of the suspension 44 may come up on the liquid layer 40 in some cases. As the method of supplying the droplets of the suspension 44 on the lower surface of the liquid layer 40, it is possible that, for example, the droplets of the suspension 44 are previously disposed dispersedly on the display electrode 102 prior to forming the liquid layer and then the liquid layer is formed. Further, it can also be considered that, after forming the liquid layer 40, a tubular dispenser having an opening on the tip thereof such as an injector needle is inserted in the liquid layer 40 from the above, and an appropriate amount of suspension 44 is supplied through the dispenser when the tip of the dispenser reaches a proper depth. By using a dispenser having a large number of needles like a pinholder, the display fluid cells 103 can be formed without requiring so much labor.

Through the process described above, a number of droplets of suspension 44 are arranged like cells separated with the partition forming liquid 110. In this case, integration of adjacent droplets of the suspension 44 hardly occurs in general. This is because there is a specific molecular arrangement in the interfacial surface between the suspension 44 and the liquid layer 40, and the molecular arrangement in the interfacial surface between the two parties functions as a cell wall to prevent the droplets of the suspension 44 from integrated with each other. Further, the droplets of the suspension 44 themselves often have charges on the surfaces, the electric charges sometimes cause the droplets of the suspension 44 to be repulsive, thus preventing the integration. Therefore, it is preferable to have the suspension 44 or the partition forming liquid 110 include an interfacial active agent or a charge control agent in order to actively charge the droplets of the suspension 44.

Thus, the droplets of the suspension 44, namely the display cells 103 are formed all over the display area. By sealing this assembly as it is in a structure for preventing the solvent or the dispersion medium from evaporating from the liquid layer 40, it can function as a display device. The reason is that, by thus configured, the integration of the droplets of the suspension 44 never occurs, therefore it can continue to function as a display device. However, in view of stability, portability, and impact resistance of the device, the partition forming liquid 110 is further solidified in the present embodiment.

Solidifying Process: FIG. 2D

As shown in FIG. 2D, the liquid layer 40 is solidified by supplying energy to the liquid layer 40 in which the display fluid cells are formed. Note that this solidifying process is optional, and is not necessary providing the liquid layer 40 can be configured so that the liquid layer 40 in the liquid state does not evaporate nor cause contraction in volume.

Here, as an example of curing the liquid layer 40, after forming the liquid layer 40, the whole of the liquid layer 40 is irradiated with ultraviolet light supplied from a ultraviolet light source 113. As a premise, a monomer for a polymer is preferably used as the solvent of the partition forming liquid 110 for forming the liquid layer 40. Because, such a monomer for a polymer has high fluidity at room temperature, and can be applied as a liquid on the one hand, and is polymerized with bridges to be a polymer and cured on the other hand when energy such as the ultraviolet light is applied. Further, other than the irradiation with the ultraviolet light, it can be polymerized by adding a curing initiator to the liquid layer 40 or executing a heating process.

It is preferable that the partition forming liquid 110 is composed of a polymeric monomer because the contraction ratio in volume after curing is small, thus the shapes of the display fluid cells 103 when injected can be maintained. On the contrary, if viscosity of the partition forming liquid 110 is adjusted by adding solvent or dispersion medium, the solvent evaporates in the drying process to cause contraction in volume. Therefore, the shapes of the display fluid cells 103 themselves may vary to be irregular. Therefore, when drying or heating the liquid layer 40, the conditions of drying or heating such as drying time, a flow rate of heated air, of the temperature need to be adjusted. In general, the lower the temperature is kept and the slower the drying or heating process proceeds, the less variation in shapes of the cells occurs.

By the process described above, the basic structure as the display device is determined. By solidifying the liquid layer 40, the positions of the display fluid cells 103 are fixed, and each of the cells is separated with the partition 41.

Laminating Process: FIGS. 3A and 3B

As shown in FIG. 3A, an adhesive 45 is applied on the cured liquid layer 40, and a substrate 301 made of resin or the like on which a opposed electrode 302 is previously formed is laminated by a dispenser 114.

As a material of the substrate 301, resin having great flexibility such as polyethylene terephthalate is used for providing flexibility to the display device as a whole. Although not shown in the drawings, aluminum oxide is preferably deposited on the substrate 301 with a thickness of about 100 nm as a barrier layer for preventing oxygen and moisture from permeating. The opposed electrode 302 is formed by depositing a predetermined metallic material such as ITO with a thickness of about 100 nm.

In order for making the display device perform display using the active matrix drive system, the opposed electrode 302 is patterned so as to be divided into sections corresponding to the pixels and electrically separated from each other to form pixel electrodes, and thin film transistors for driving the respective pixel electrodes. Further, if the display device is driven by a passive matrix system, a pattern is provided so that the display electrodes 102 and the opposed electrodes 302 intersect with each other in each of the pixel areas.

In the lamination of the substrate 101 with the substrate 301, after applying the adhesive 45 on the cured liquid layer 40, the substrate 301 on which the opposed electrodes 302 are formed is supplied from the dispenser 114, and the substrates are laminated from edge portions thereof in sequence. The adhesive can be provided to the opposed electrodes 302. As the adhesive, an acrylic emulsion adhesive or the like can be used.

As described above, according to the manufacturing method of the first embodiment, the display fluid cells 103 can easily be included inside the liquid layer without forming partitions using a photolithography method or a mold method or without manufacturing microcapsules. Therefore, according to the present embodiment, firstly, the display fluid cells 103 can be disposed in the desired positions of the liquid layer 40 as easy as anything in comparison with the cases using other methods. Secondly, since the step of forming the partition is not necessary, the waste in the partition material can be suppressed to the minimum.

Further, according to the first embodiment, since the positions in which the cells are formed can be controlled very precisely using the liquid ejecting device, the microscopic cells containing display fluid can be formed with high-resolution.

Further, according to the first embodiment, the step of solidifying the partition forming liquid is provided, the positions of the display fluid cells 103 can be fixed, thus the display device, which is stable for long period of time and has strong impact resistance, can be provided.

### Second Embodiment

A second embodiment of the invention is for exemplifying the case in which the invention is applied to the manufacture of an electrophoretic display device capable of displaying color images. In the following explanations, descriptions are provided focusing on the differences from the first embodiment described above, and descriptions for the same sections will be omitted.

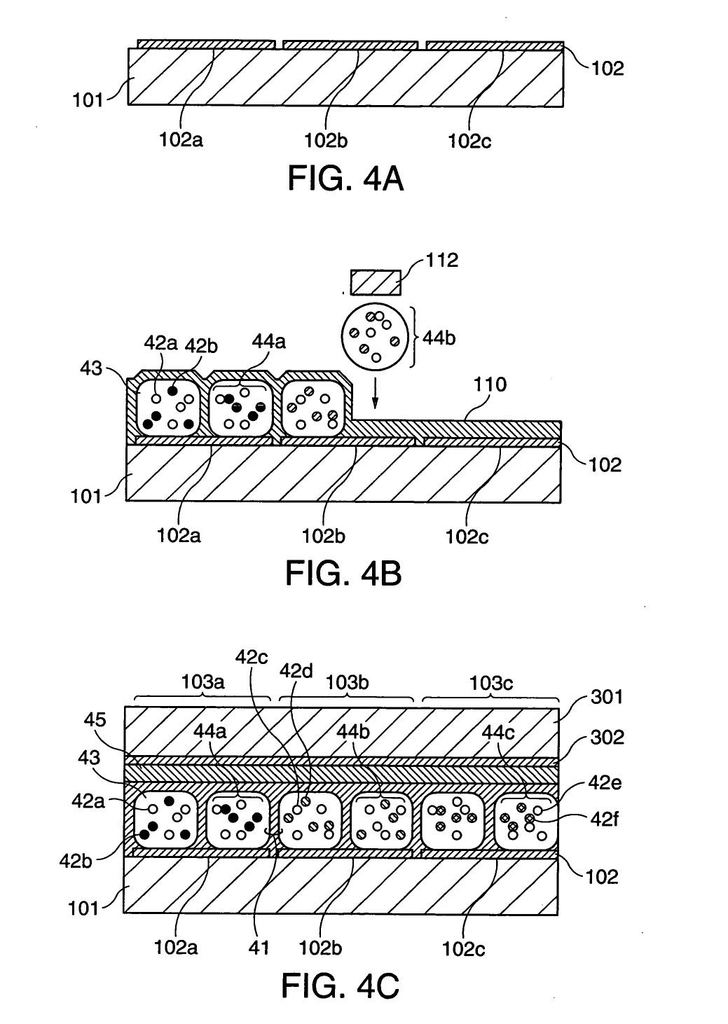

FIG. 4C is a schematic cross-sectional view of the electrophoretic display device according to the present embodiment. The cross-sectional view also shows an enlarged cross-sectional view of a section corresponding to a single pixel area.

As shown in FIG. 4C, the display device of the present embodiment has the display electrodes patterned to be electrically divided into three electrodes, a red displaying electrode 102a, a green displaying electrode 102b, and a blue displaying electrode 102c. Each of the electrodes is provided with a voltage separately in accordance with a drive signal corresponding to respective color tones. The display fluid cell capable of displaying the corresponding color tone is formed for each of the electrodes.

In the first embodiment, the monochromatic display is provided because the suspension 44 of the display fluid is composed of a single species, and the variation in the color tone is limited. In contrast, in the second embodiment, by displaying a number of primary colors, the color display can be realized. As a method of displaying color images, it can be considered that the suspension for the display fluid of two kinds, generally of three kinds, is manufactured, and the suspension is disposed on the different electrodes by each kind. By synthesizing the display colors of the number of primary colors, a desired color tone can be displayed. Hereinafter, an example of using display colors corresponding to the three primary colors of red, green, and blue will be described.

The red display fluid cells 103a are provided to an area of the red display electrode 102a, and are filled with the suspension 44a, which can be switched between red and white in accordance with presence or absence of the electric field. The first particles 42a have the color tone of white, and the second particles 42b have the color tone of red. The green display fluid cells 103b are provided to an area of the green display electrode 102b, and are filled with the suspension 44b, which can be switched between green and white in accordance with presence or absence of the electric field. The first particles 42c have the color tone of white, and the second particles 42d have the color tone of green. The blue display fluid cells 103c are provided to an area of the blue display electrode 102c, and are filled with the suspension 44c, which can be switched between blue and white in accordance with presence or absence of the electric field. The first particles 42e have the color tone of white, and the second particles 42f have the color tone of blue. The dispersion medium 43 for each of the suspensions is set to be an achromatic color, for example, white.

The opposed electrode 302 is formed to be common at least to the pixels of each of the colors. It is arranged that, by applying a voltage, not applying the voltage, or applying a voltage of the opposite polarity to each of the display electrodes taking the opposed electrode 302 as the reference, the color tone observed from the display surface can be varied. For example, it is assumed that the first particles 42a, 42c, and 42e are all charged positively, the second particles 42b, 42d, and 42f are respectively charged negatively, and each of the display electrodes is provided with a positive voltage with respect to the opposed electrode 302. In this configuration, for example, the voltage is applied only to the red display electrodes 102a, the second particles 42b, which are the particles charged negatively, are accumulated in the side of the red display electrode 102a in the red display fluid cells 103a. Since other display fluid cells 103b, 103c are not provided with a voltage, the color tone of the dispersion medium, namely white is observed. In this condition, by observing from the substrate 101, the chromatic color of red can only be recognized, and therefore, as a whole, red display is provided. Similarly, by applying the voltage only to the green display electrode 102b, green display is provided, and by applying the voltage only to the blue display electrode 102c, blue display is provided. Further, when the voltage is applied to plural display electrodes, a color tone obtained by synthesizing the color tones corresponding to the display electrodes is displayed.

With reference to FIGS. 4A through 4C, a manufacturing method according to the second embodiment will be explained.

As shown in FIG. 4A, the display electrodes 102a through 102c electrically separated for each of the color tones are formed on the substrate 101 by patterning. Each of the display electrodes is composed of a pattern having a width of no greater than 1 mm in, for example, a high-resolution display device. Even in the case with such a fine pattern, according to the present invention, the display fluid cells for displaying each of the color tones can be formed on the electrode corresponding the respective color tones.

The liquid layer forming process is the same as in the case of the first embodiment. Namely, the liquid layer 40 is formed of the partition forming liquid 110.

As shown in FIG. 4B, after forming the liquid layer 40 using the partition forming liquid 110, the respective suspensions are ejected from the liquid ejecting device 112. In this process, the liquid ejecting device 112 is provided for each of the color tones, namely three liquid ejecting devices 112 are provided, and each of the liquid ejecting devices 112 is provided with the respective display fluids to separately eject each of the display fluids. For example, the liquid ejecting device 112 for red is supplied with the red display suspension 44a, and the droplets of the suspension 44a are injected on the red display electrode 102a. The liquid ejecting device 112 for green is supplied with the green display suspension 44b to inject the droplets of the suspension 44b on the green display electrode 102b. The liquid ejecting device 112 for blue is supplied with the blue display suspension 44c to inject the droplets of the suspension 44c on the blue display electrode 102c. FIG. 4B shows a state in which the injection of the suspension 44a for red display is completed and the injection of the suspension 44b for green display is in progress.

After the injection of all suspensions is completed and the red display fluid cells 103a, the green display fluid cells 103b, and the blue display fluid cells 103c are formed, the solidification of the liquid layer 40 is optionally executed. And, as is the case with the first embodiment, the substrate 301 provided with the opposed electrode 302 is laminated thereto with the adhesive 45.

As described above, since the second embodiment is provided with a similar structure and process to the first embodiment, the same advantages can be obtained. In addition, since the different kinds of display fluid are provided on the same substrate, color images can be displayed.

In particular, according to the present embodiment, since the cells containing an appropriate amount of electrophoretic display fluid can easily be formed in the desired positions, a high-resolution color display device can be manufactured with relative ease.

### Third Embodiment

A third embodiment of the invention relates to a specific example of an electric apparatus including the display device manufactured in the embodiments described above.

Electrophoretic Device

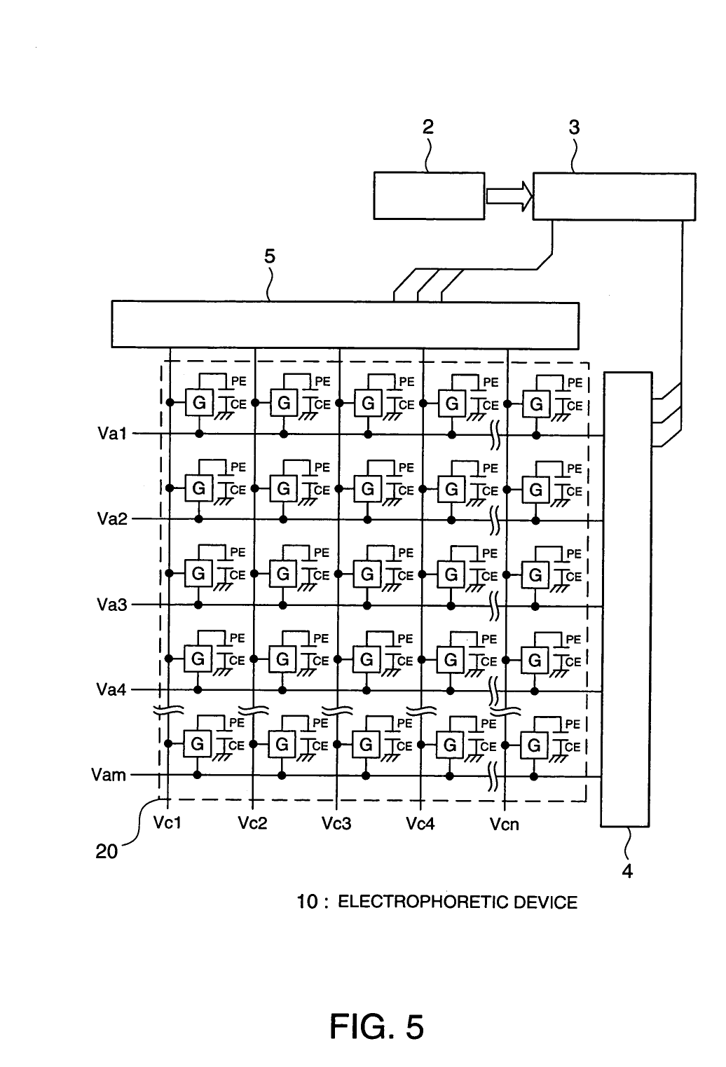

FIG. 5 shows a block diagram of an electrophoretic device 10 including a drive section for driving the display device according to the invention.

As shown in FIG. 5, the electrophoretic device 10 is equipped with the display device 20 manufactured with the method described above and a circuit configuration for an active matrix drive system. The display device 20 is further provided with a number of scan lines Va1 through Vam and a number of drive lines Vc1 through Vcn. The pixel electrode PE and the common electrode CE in each of the pixels respectively correspond to the display electrode 102 and the opposed electrode 302 in each of the embodiments described above. In each of the pixels, a pixel drive circuit G is disposed. The pixel drive circuit G operates so that the pixel electrode PE becomes in the positive potential with respect to the common electrode CE in a condition in which the scan line Va and the drive line Vc are both switched on, and the pixel electrode PE becomes in the negative potential with respect to the common electrode CE in other conditions. A driver 4 is for driving each of the scan lines Va1 through Vam, and a driver 5 is for driving each of the driving lines Vc1 through Vcm. The drivers 4 and 5 are connected to a display control circuit 3. The display control circuit 3 is for determining drive voltages of the scan lines Va and the drive lines Vc in accordance with an image supplied from, for example, a computer, and for providing drive information.

According to the electrophoretic device 10 configured as described above, when image information such as a predetermined character or a line drawing is supplied from a computer 2, the direction of the electric field between the pixel electrode PE and the common electrode CE in each of the pixels is changed in accordance with the on/off information of that pixel. Therefore, the particles in the display fluid cells 103 corresponding to the pixel electrode PE of each of the pixels migrate in accordance with the electric field to be accumulated in the electrode or not, thus the color tone to be observed changes. Thus, the information corresponding to the image supplied from the computer 2 can be observed.

Large-Screen Television

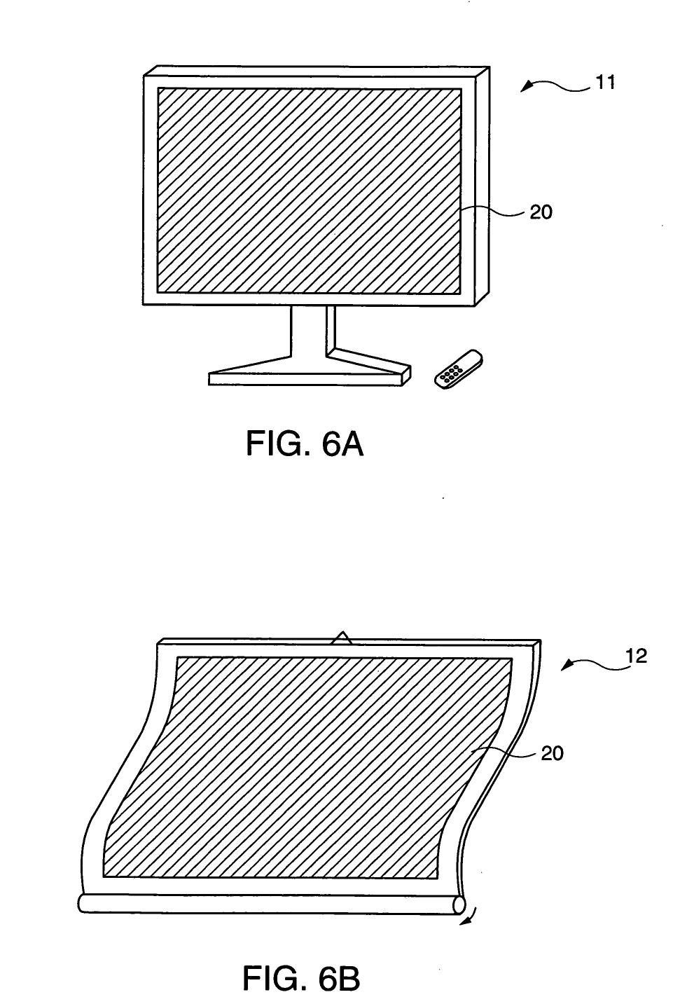

FIG. 6A shows an example of an electric apparatus applying the display device manufactured using the invention to the display section of the large-screen television.

As shown in FIG. 6A, the display device 20 is implemented to the display surface of the large-screen television 11. As the display device 20, the display device 20 described above is used. Therefore, the information display is performed in accordance with the action of the particles, which migrate in the display fluid cells. As described above, the display device according to the invention can be applied to the display section of the flat display. Further, according to the invention, the display device can be manufactured irrespective of the area of the display region, the invention is suitable for the method of manufacturing the large-screen display like the present embodiment with low cost.

Electronic Paper

FIG. 6B shows an example of an electric apparatus applying the display device manufactured using the invention to the display surface of an electronic paper 12.

As shown in FIG. 6B, the electronic paper 12 is equipped with the display device 20 manufactured in the embodiment of the invention as it is. In particular, since a plastic film having flexibility is used as the substrate 101 or 302 in the electronic paper 12, the electronic paper 12 can be unrolled as a wall hanging, or rolled to be stored as illustrated by the arrow. As described above, the display device according to the invention can be applied to the display section having flexibility. Since there is no limitation in the size of manufacture as is the case described above even if flexibility is required to the display section, the invention can be applied to manufacture from a small size display to a large size display with freedom.

Note that the range of the electric apparatus to which the invention can be applied is not limited to those described above, but the invention can be applied to any equipment having a configuration to be sold and transferred in a commercial transaction and applying changes in a visible color tone caused by migration of charged particles. For example, display devices including those with large screens, a videocassette recorder of a viewfinder type or of a direct view monitor type, a car navigation system, a pager, an electronic notepad, an electronic calculator, an electronic newspaper, a word processor, a personal computer, a workstation, a video phone, a POS terminal, an instrument equipped with a touch panel can be cited. The display device according to the invention can be applied as a display section of each of the above instruments.

Further, in addition to the examples of instruments described above, the invention can also be applied to those belonging to real estate such as a wall face configured so that an electric field can be applied thereto, or those belonging to a vehicle, a flight vehicle, boats and ships.

### OTHER MODIFIED EXAMPLES

The invention is not limited to the embodiments described above, but can be applied in various modified forms.

For example, although the electrophoretic display liquid using the suspension dispersing at least one kind of particles in the dispersion medium is used as the display fluid in the embodiments described above, the invention is not so limited. For example, liquid crystal materials can be used as the display fluid. Because, the liquid crystal materials can also divided into cells for displaying, and even if the liquid layer is used, the invention is preferable.

Further, there is no limitation in the driving configuration of the display device. For example, in the embodiments described above, a so-called vertical migration type of electrophoretic device is used. The vertical migration type of electrophoretic device applies electric field in a direction perpendicular to the display surface to make the charged particles migrate in the perpendicular direction thereby changing the color tone to display images. However, the invention can be applied to a so-called horizontal migration type of electrophoretic device. The horizontal migration type of electrophoretic device applies electric field in a direction parallel to the display surface to make the charged particles migrate in the parallel direction thereby changing the color tone to display images.

Further, regarding the drive system of the electric apparatus (display device), either of the active matrix drive system or the passive matrix drive system can be adopted.

What is claimed is:

1. A method of manufacturing a display device, comprising:
applying a first liquid material on a substrate to form a liquid layer; and injecting a plurality of droplets of a second liquid material to the liquid layer to form a plurality of cells in the liquid layer, each of the cells being separated to each other, the liquid layer having an interfacial surface between the first liquid material and a second liquid material.

2. A method of manufacturing a display device using a display fluid, comprising:
applying a first liquid material to a first substrate to form a liquid layer over a first electrode and a second electrode, the first electrode and the second electrode being formed over the first substrate; and
injecting a first droplet and a second droplet to the liquid layer to form a first cell and a second cell in the liquid layer, the first cell being formed above the first electrode and the second cell being formed above the second electrode, the first droplet and the second droplet including a second liquid material, each of the cells being separated to each other, the liquid layer having an interfacial surface between the first liquid material and a second liquid material.

3. The method of manufacturing a display device according to claim 1, the first liquid material including a charged particle and a dispersion medium.

4. The method of manufacturing a display device according to claim 1, the first liquid material including a liquid crystal material.

5. The method of manufacturing a display device according to claim 1, the first liquid material and the second liquid material not being dispersed or dissolved by each other.

6. The method of manufacturing a display device according to claim 1, the first liquid material including a polymeric monomer.

7. The method of manufacturing a display device according to claim 6, further comprising:
polymerizing the liquid layer by irradiating with a light.

8. The method of manufacturing a display device according to claim 6, further comprising:
polymerizing the liquid layer by adding a curing initiator to the liquid layer.

9. The method of manufacturing a display device according to claim 1, a plurality of droplets of a second liquid material to the liquid layer by liquid ejection device.

10. The method of manufacturing a display device according to claim 1, a plurality of droplets of a second liquid material to the liquid layer by dispenser that has at least an injector needle.

11. The method of manufacturing a display device according to claim 2, further comprising:
forming an opposite electrode over the liquid layer, the opposite electrode being formed on a second substrate to form at least a first pixel and a second pixel, the first pixel overlapping with the first electrode and the first cell, the first pixel displaying a first color, the second pixel overlapping with the second electrode and the second cell, the second pixel displaying a second color, the first color and a second color being different.

12. A method of manufacturing an electric apparatus including the method of manufacturing a display device according to claim 1.
